(19) United States
(12) Patent Application Publication
(10) Pub. No.: US 2026/0187104 A1
(43) Pub. Date: Jul. 2, 2026

(54) Key Phrase Recommendation Based On Token Correspondence

(71) Applicant: eBay Inc., San Jose, CA (US)

(72) Inventors: Soumik Dey, San Jose, CA (US); Binbin Li, Cupertino, CA (US); Kamesh Madduri, State College, PA (US); Ashirbad Mishra, State College, PA (US); Hansi Wu, Cupertino, CA (US); Jinyu Zhao, San Jose, CA (US); Julie Cheng, Los Gatos, CA (US)

(73) Assignee: eBay Inc., San Jose, CA (US)

(21) Appl. No.: 19/003,304

(22) Filed: Dec. 27, 2024

(51) Int. Cl. G06F 16/332; G06F 40/284; G06F 40/289

(52) U.S. Cl. CPC G06F 16/3322; G06F 40/284; G06F 40/289

(57) ABSTRACT

Key phrase recommendation based on token correspondence is described. In one or more implementations, a plurality of user queries entered via a search feature of a listing platform is received. Key phrases are extracted from the plurality of user queries. The key phrases are associated with an item category of the listing platform, and each have a search count that exceeds a threshold. Further, an item title of an item listed via the listing platform in the item category is obtained, and the item title includes title tokens. The key phrases are ranked based, in part, on quantities of the title tokens included in the key phrases, and the ranked key phrases are output.

### BACKGROUND

Key phrase recommendation is a technique used in various domains, including e-commerce, search engines, and content creation. Generally, key phrase recommendation techniques identify and suggest words or phrases that enhance user experience, visibility, and engagement of content items. For example, recommended key phrases, when searched, are effective to surface the content item or similar content items within a search results page.

### SUMMARY

Key phrase recommendation based on token correspondence is described. As part of this, a key phrase recommendation system receives a plurality of user queries that have been entered via a search feature of a listing platform. Key phrases are extracted from the user queries. The extracted key phrases are associated with an item category and have a search count that exceeds a threshold. The key phrase recommendation system generates a bipartite graph for the item category, and the bipartite graph includes the key phrases, phrase tokens occurring within the key phrases, and edges connecting the phrase tokens to the key phrases in which the phrase tokens occur. At inference, an item title of an item listed via the listing platform is obtained, and the item title is tokenized into title tokens. Using the bipartite graph, the key phrase recommendation system determines quantities of the title tokens included in respective key phrases. Furthermore, the key phrase recommendation system ranks the key phrases based, in part, on quantities of the title tokens included in the key phrases. The key phrases are output for display in a user interface in ranked order.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of indexing a storage device in accordance with the described techniques.

FIG. 3 depicts an example of key phrase recommendation in accordance with the described techniques.

FIG. 4 depicts an example of tuning parameters of a key phrase recommendation system.

FIG. 5 is an example of a serving architecture that is operable to employ techniques described herein.

FIG. 6 depicts a procedure in an example implementation of key phrase recommendation based on token correspondence.

FIG. 7 illustrates an example of a system that may implement the various techniques described herein.

### DETAILED DESCRIPTION

### Overview

Listing platforms of online marketplaces are often implemented for key phrase recommendation to recommend key phrases for items listed via the listing platform. Conventional techniques for key phrase recommendations, however, utilize extreme multi-label classification (XMC) models for this task. In accordance with XMC, an item is paired with a key phrase if the item is engaged with (e.g., clicked) at least a threshold number of times when the key phrase is searched. Given this, training data used by conventional techniques is biased towards popular items. Indeed, unpopular items (e.g., which make up a majority of listings on the online marketplace typically receive sufficient engagement to be paired with just one key phrase within this training data. Conventionally-configured recommendation systems inherit this popularity bias in the training data, and therefore, produce an insufficient number of key phrases for unpopular items. Moreover, conventional XMC models tend to recommend tail key phrases (e.g., key phrases that are entered infrequently) rather than head key phrases (e.g., key phrases that are entered frequently), despite users of the online marketplace preferring head key phrases over tail key phrases in the context of key phrase recommendation.

To address these limitations, key phrase recommendation based on token correspondence is described. The described techniques involve a listing platform implemented as part of an online marketplace having a database of listings for items. Further, the listings include real-time listing data describing attributes of the items, such as titles of the items (e.g., item titles), and categories of the items, e.g., item categories. In particular, the online marketplace employs a category hierarchy (e.g., a tree structure) in which in which more specific child categories (e.g., smartphones) fall under more generic parent categories, e.g., electronics. In this context, an item category of an item is defined as a leaf category (e.g., the lowest-level category of the tree structure) into which the item is categorized.

In accordance with the described techniques, the key phrase recommendation system obtains a plurality of item key phrases entered via the search feature of the listing platform. Further, the key phrase recommendation system determines item categories of the plurality of key phrases. Notably, the online marketplace uses a search result ranking algorithm to rank search results for display in a user interface responsive to a user query. In one example, an item category of a key phrase is the top-ranked listing as ranked by the search result ranking algorithm and retrieved responsive to the key phrase being entered as a user query via the search feature of the listing platform. In addition, each of the key phrases include a search count and a recall count. The search count of a key phrase is the number of times the key phrase has been entered as part of a user query via the search feature over some previous time interval. The recall count of a key phrase is the number of search results (e.g., listings) retrieved by the search feature responsive to the key phrase being entered as a user query via the search feature.

Here, the key phrase recommendation system filters key phrases associated with an item category based on the search count. As part of this, the key phrase recommendation system retains popular key phrases having a search count that meets a threshold, and discards (e.g., filters out) unpopular key phrases having a search count that fails to meet the threshold. Using the popular key phrases within the item category, the key phrase recommendation system builds a bipartite graph. In particular, the bipartite graph includes the popular key phrases of the item category, phrase tokens occurring in the popular key phrases, and edges connecting the phrase tokens to the popular key phrases in which the phrase tokens occur. Notably, a phrase token “occurs” in a popular key phrase if the phrase token is a token (e.g., a word, a character, a number, etc.) within the popular key phrase.

After the bipartite graph is constructed, the key phrase recommendation system obtains an item having an item title and categorized within the item category of the bipartite graph. The key phrase recommendation system tokenizes the item title into title tokens, and identifies the phrase tokens that are also title tokens, e.g., matching tokens. Relevant key phrases are identified as the popular key phrases in the bipartite graph connected via the edges to at least one matching token. Moreover, the key phrase recommendation system determines quantities of the matching tokens included in the relevant key phrases. Given a relevant key phrase, the quantity is the number of matching tokens connected to the relevant key phrase in the bipartite graph.

Next, the key phrase recommendation system is configured to determine a label title alignment for each of the relevant key phrases based on the quantities. The label title alignment of a relevant key phrase captures a relationship between the quantity of matching tokens and a difference between the quantity of matching tokens and a quantity of total tokens in the relevant key phrase. The key phrase recommendation system then ranks the relevant key phrases in descending order from highest label title alignment to lowest label title alignment. If multiple relevant key phrases have a same label title alignment, then the multiple relevant key phrases are ranked in descending order from highest search count to lowest search count. If multiple relevant key phrases have a same label title alignment and a same search count, then the multiple relevant key phrases are ranked in ascending order from lowest recall count to highest recall count. Then, the key phrase recommendation system outputs, as recommended key phrases, a top-ranked subset of the relevant key phrases for display in a user interface in the ranked order.

Thus, the described techniques generate the recommended key phrases independently of engagement data describing user interactions with search results (e.g., listings of items) that the key phrases produce responsive to being searched via the search feature. Rather, the described techniques generate the recommended key phrases for an item based on token correspondence between the item title and the popular key phrases that are within the item category of the item. By decoupling the key phrases from engagement data and using popular key phrases within the item's category to recommend key phrases for the item, the described techniques maintain the desired bias towards recommending head key phrases (e.g., which are frequently searched via the search features), while removing the negative bias against unpopular items. Thus, the described techniques improve key phrase recommendations over conventional techniques by increasing the number of recommended key phrases for unpopular items, and increasing the proportion of recommended head key phrases (as opposed to tail key phrases).

Moreover, the described techniques adopt a graph-based approach for key phrase recommendation, which contrasts with conventional neural model approaches. The bipartite graphs are constructable in a significantly decreased amount of time, as compared to training a neural model. Due to the reduced training time, the described techniques enable frequent model refreshes, e.g., so the key phrase recommendation system can frequently incorporate new key phrases searched on the online marketplace. In addition, at inference time, the described techniques use lightweight graph traversal or lookup operations to identify the relevant key phrases rather than the complex operations (e.g., matrix multiplications, activation functions, and the like) utilized by neural model-based approaches, which reduces computational complexity and inference latency. Moreover, the bipartite graphs occupy significantly less memory than a neural model-based approach. In summary, the described techniques increase key phrase recommendations for unpopular items and increase head key phrase proportion, while utilizing a graph-based approach that is smaller (e.g., in terms of memory occupation), and faster, e.g., in terms of training speed and inference latency.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

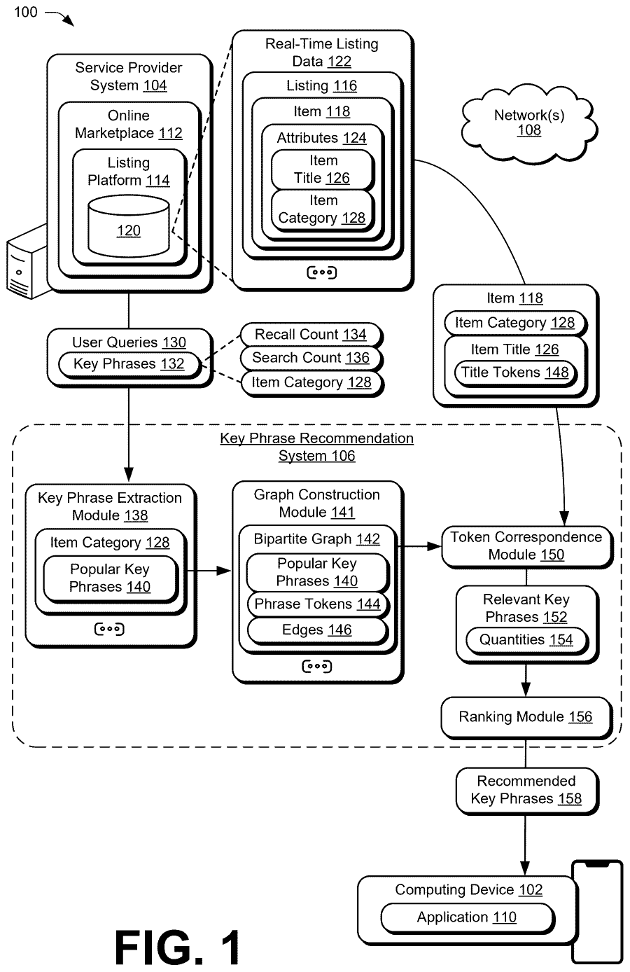

FIG. 1 is an illustration of an environment 100 in an example implementation that is operable to employ techniques described herein. The environment 100 includes a computing device 102, a service provider system 104, and a key phrase recommendation system 106. In one or more implementations, the computing device 102, the service provider system 104, and the key phrase recommendation system 106 are communicatively coupled, one to another, via network(s) 108. One example of the network(s) 108 is the Internet, although one or more of the computing device 102, the service provider system 104, and the key phrase recommendation system 106 may be communicatively coupled using one or more different connections or different networks in various implementations.

Although the key phrase recommendation system 106 is depicted in the environment 100 as being separate from the computing device 102 and the service provider system 104, in one or more implementations, an entirety or various portions of the key phrase recommendation system 106 are implemented at or by the computing device 102 and/or the service provider system 104. In at least one implementation, for example, at least a portion of the key phrase recommendation system 106 is implemented by an application 110 of the computing device 102 and/or using various resources of the computing device 102, such as hardware resources, an operating system, firmware, and so forth. Alternatively or additionally, at least a portion of the key phrase recommendation system 106 is implemented by resources (e.g., server-based storage, processing, and so on) of the service provider system 104. Alternatively or additionally, at least a portion of the key phrase recommendation system 106 is implemented using a third-party service, such as a web services platform that provides one or more hardware and/or other computing resources to support provision of services by web service providers.

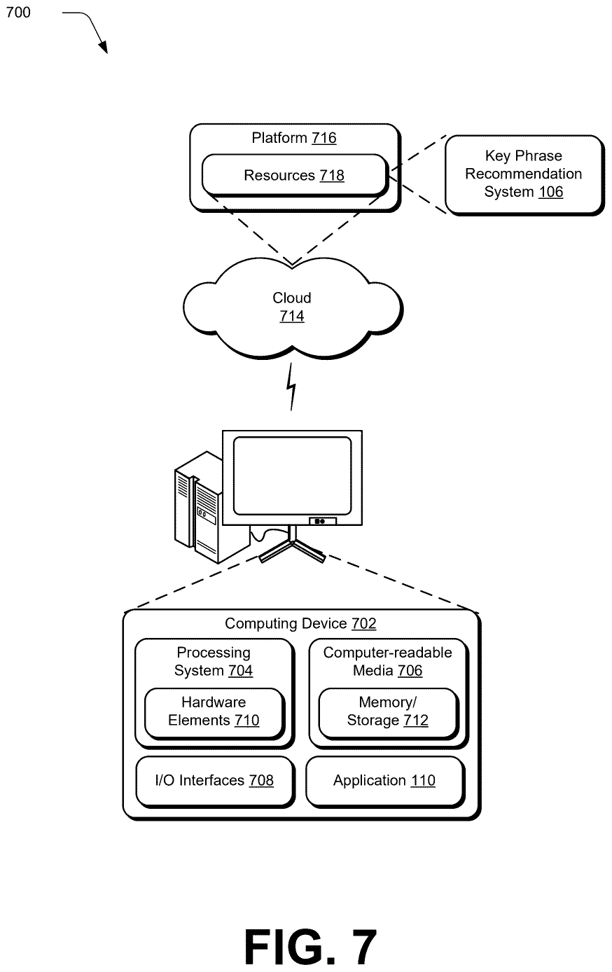

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm or data center utilized to perform operations “over the cloud” as further described in relation to FIG. 7.

In at least one implementation, the application 110 supports communication of data across the network(s) 108, such as between the computing device 102 and the service provider system 104 and/or between the computing device 102 and the key phrase recommendation system 106. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives user input via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112's website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104, computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 includes a listing platform 114 providing functionality for generating listings 116 for items 118 and to exposing those listings 116 (e.g., publishing them) across the network(s) 108 to one or more computing devices, including to the computing device 102. For example, the online marketplace 112 may generate listings 116 for items 118 for sale and expose those listings 116 to computing devices, such that users of the computing devices can interact with the listings 116 via user interfaces to initiate transactions (e.g., purchases, add to wish lists, share, and so on) in relation to the respective item 118 or items 118 of the listings 116. In accordance with the described techniques, the online marketplace 112 is configured to generate listings 116 for one or more types of physical goods or property (e.g., clothing and/or clothing accessories, collectibles, furniture, decorative items, textiles, luxury items, electronics, real property, physical computer-readable storage having one or more video games or other digital content stored thereon, and so on), services (e.g., babysitting, dog walking, house cleaning, home repair, general contracting, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes storage device 120, which is depicted as maintaining real-time listing data 122. The real-time listing data 122 includes listings 116 of items 118 on the online marketplace 112. The storage device 120 may represent one or more databases and/or other types of storage capable of storing the real-time listing data 122. Examples of the storage device 120 include, but are not limited to, mass storage and virtual storage. In one or more implementations, for example, the storage device 120 may be virtualized across a plurality of data centers and/or cloud-based storage devices. The service provider system 104 may implement the online marketplace 112 by using servers that execute stored instructions to deploy various services of the service provider system 104, such that those services perform numerous computations which are effective to provide the functionality described above and below. It is to be appreciated that the online marketplace 112 may include more, fewer, or different components without departing from the spirit or scope described herein.

In one or more implementations, the online marketplace 112 is accessible by decentralized computing devices that correspond to “clients” of the online marketplace 112, e.g., users that have accounts with the online marketplace 112 and/or that access the online marketplace as a “guest” that is not signed to such an account or tracked as a user with an account.

In at least some scenarios, but for the provision of accounts and system guardrails implemented by aspects of the online marketplace 112 (e.g., user interfaces of the application 110), the online marketplace 112 does not generally control actions of the users to use functionality of the online marketplace 112 to list items 118 thereon. For instance, a number (e.g., most) of the users of the online marketplace 112 may not be employed by or otherwise similarly controlled by a company associated with the online marketplace 112. In this way, the users of the online marketplace 112 may exert more control over the items listed with the online marketplace 112 (e.g., the items that those users decide to list through the online marketplace 112) than the company associated with the online marketplace 112 (or its employees or agents).

Users that cause items to be listed on the online marketplace 112 may be referred to as “sellers,” whereas users that purchase or otherwise obtain items listed on the online marketplace 112 via its listings may be referred to as “buyers.” Sellers and buyers both interact with user interfaces of the online marketplace 112 (e.g., via the application 110) to perform the desired functionality. In addition, an individual user of the online marketplace 112 can interact via the interfaces to be both a seller and a buyer on the online marketplace 112, such as by interacting with the user interfaces to have caused one or more items 118 to be listed on the online marketplace 112 and by interacting with the user interfaces to purchase one or more items 118 from the listings 116 of the online marketplace 112.

A user that is a seller, for instance, may interact with one or more user interfaces of the online marketplace 112 (e.g., output via the application 110) to provide information about one or more items 118 which the user is causing to be listed on the online marketplace 112. Such user interfaces may include prompts that instruct, or guide, users that are sellers to provide various information about items being listed. Examples of information that such interfaces prompt sellers for and that those users provide include but are not limited an item title, an item description, one or more prices (e.g., to purchase the item 118 now and/or a minimum starting bid for the item 118), brand information, size, year, color(s), shipping information (e.g., cost and/or types available), delivery information, return information, payment information, images, videos, models, authenticity information, item history (e.g., chain of custody), and condition (of the item 118), to name a few.

One or more portions of such information may be referred to herein as attributes 124 of the listing 116. For example, an item title 126 of the listing 116 may be an attribute of the listing 116, an item description may be an attribute of the listing 116, one or more images uploaded or selected for the listing 116 may be one or more attributes of the listing 116, color(s) of the item 118 may be an attribute of the listing 116, an item category 128 of the item may be an attribute of the listing 116, and so forth. In one or more implementations, the online marketplace 112 categorizes listings 116 using a category hierarchy (e.g., a tree structure) in which more specific child categories (e.g., smartphones) fall under more generic parent categories, e.g., electronics. In accordance with the techniques discussed herein, the item category 128 of a listing 116 for an item 118 is the leaf category (e.g., lowest-level category of the tree structure) into which the item 118 is categorized.

In one or more implementations, the online marketplace 112 saves and maintains the input information for a listing 116 in the storage device 120 in fields of a data structure or data record populated for the listing 116, where a given field and the information populated and maintained for the given field correspond to a particular attribute 124 of the listing 116. For instance, an ‘item title’ field of such a data structure or data record may be populated with information (e.g., text) input into a user interface by a seller of a listing 116. The title field and the information input by the user as the item title 126 of the listing 116 correspond to an attribute 124 of the listing 116. In one or more implementations, one or more of the attributes 124 of a listing 116 may be derived and then populated by the online marketplace 112, such as by the online marketplace 112 processing one or more portions of the information input by a user to populate one or more respective attributes 124 of the listing 116.

In various implementations, the online marketplace 112 and/or the listing platform 114 are configured to implement a search feature (e.g., a search engine) for enabling a user of the computing device 102 to search for specific listings 116 on the online marketplace 112. For example, the application 110 exposes a user interface of the online marketplace 112 for display by the computing device 102. The user interface, for example, includes user interface elements (e.g., a search bar and selectable search filters) via which the user provides input to specify characteristics of an item 118 that the user desires to view, purchase, bid on, etc. In response to receiving a user query 130, the search feature surfaces, in the user interface, listings 116 that most closely resemble the user query 130. More specifically, the search feature retrieves listings 116 that match the user query 130 from the storage device 120 (e.g., a recall set of the listings 116), and ranks the retrieved listings 116 using a ranking algorithm for display in the user interface. In various implementations, the ranking algorithm considers various metrics when ranking the retrieved listings, one example of which is relevance of the item 118 of the listing 116 to the user query 130.

Although not illustrated, the storage device 120, additionally maintains query data (e.g., search logs) in various implementations. The query data, for instance, includes user queries 130 entered via the search feature of the listing platform 114, as well as key phrases 132 occurring within the user queries 130. Notably, a key phrase 132 occurs within a user query 130 if the key phrase 132 is the user query 130 (in its entirety) or if the key phrase 132 makes up a portion of the key phrase 132. It should be noted that the term key phrase 132 includes singular tokens and words, or phrases of multiple tokens and words.

The query data additionally includes, for each key phrase 132, a recall count 134, a search count 136, and an item category 128. Here, the recall count 134 of a key phrase 132 is the number of search results (e.g., listings 116) retrieved by the search feature responsive to the key phrase 132 being entered as a user query 130 via the search feature. Furthermore, the search count 136 of a key phrase 132 refers to a number of times the key phrase 132 has been entered as part of a user query 130 via the search feature over some previous time interval, e.g., over the past week.

Moreover, the item category 128 of a key phrase 132 is the item category 128 (e.g., the root category) of a top-ranked listing 116 as ranked by the ranking algorithm and retrieved responsive to the key phrase 132 being entered via the search feature. Additionally or alternatively, multiple item categories 128 are associated with a key phrase 132, and the multiple item categories 128 are reflected in a top-ranked subset of listings 116 as ranked by the ranking algorithm and retrieved responsive to the key phrase 132 being entered. Responsive to the key phrase 132 being entered as a user query 130 via the search feature, for instance, the search feature retrieves and ranks the items 118 for display in the user interface. In one example, the item category 128 of the key phrase 132 is the item category 128 of the listing 116 that is ranked for display in a most prominent position in the user interface, e.g., at the top of a search results page. In another example, the item categories 128 of the key phrase 132 are the item categories 128 of multiple listings 116 that are ranked for display in a first page of search results. In other words, although the key phrases 132 are depicted as associated with a single item category 128, a key phrase 132 can be duplicated across multiple item categories 128.

As shown, the key phrase recommendation system 106 receives a plurality of key phrases 132, and each key phrase 132 is associated with query data describing the recall count 134, the search count 136, and the item category 128 of the key phrase 132. In particular, the key phrases 132 are provided as input to a key phrase extraction module 138, which extracts, for each item category 128, popular key phrases 140 that satisfy a threshold search count. For example, the key phrase extraction module 138 extracts, from the query data, popular key phrases 140 having the search counts 136 that satisfy (e.g., exceed) the threshold search count. Furthermore, the key phrase extraction module 138 groups the popular key phrases 140 according to the item categories 128, so that each item category 128 includes the popular key phrases 140 categorized within the item category 128.

The item categories 128 having the popular key phrases 140 are provided as input to a graph construction module 141. Generally, the graph construction module 141 is configured to generate a bipartite graph 142 for each item category 128. A bipartite graph 142 constructed for an item category 128, for instance, includes the popular key phrases 140 of the item category 128, phrase tokens 144 occurring in the popular key phrases 140, and edges 146 connecting the phrase tokens 144 to the popular key phrases 140 in which they occur. Notably, a phrase token 144 “occurs” in a popular key phrase 140 if the phrase token 144 is a token (e.g., a word, a character, a number, etc.) within the popular key phrase 140.

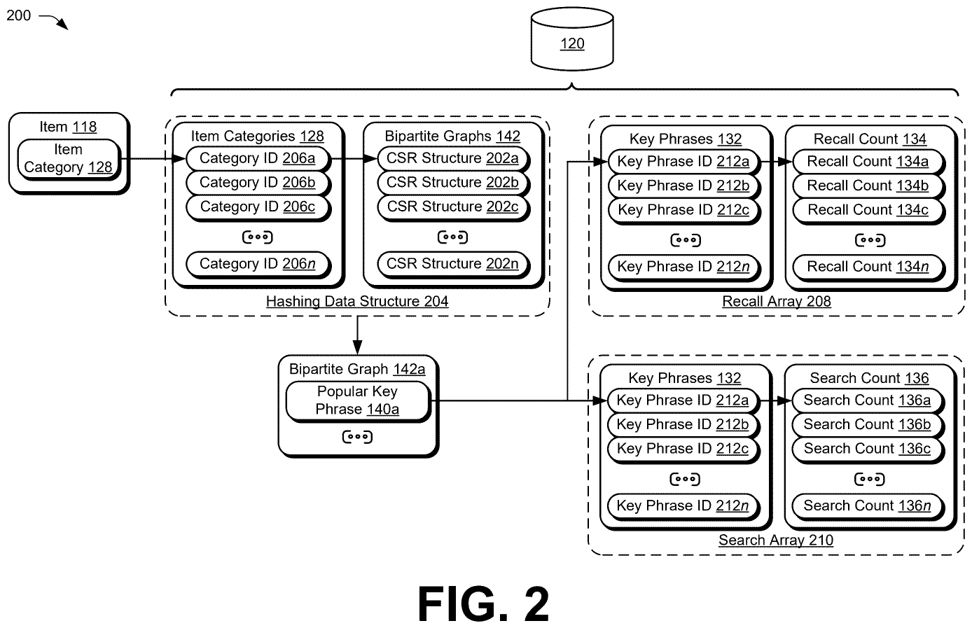

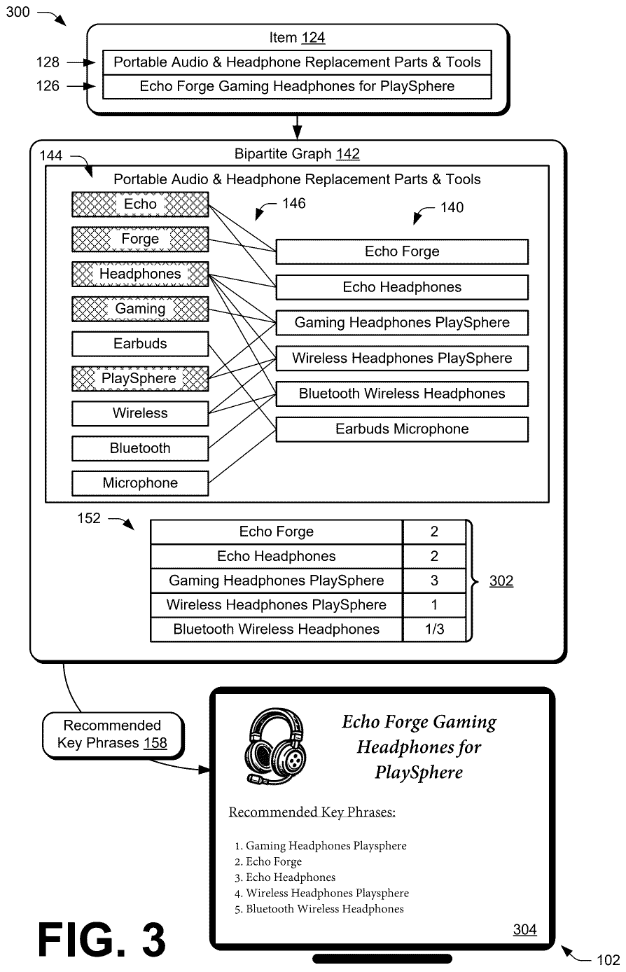

Generally, a bipartite graph is a data structure including vertices divided into two disjoint subsets, in which no two vertices in a same subset are connected by an edge, but rather all edges in the bipartite graph connect a vertex in one subset to a vertex in another subset. In this context, the bipartite graph 142 of an item category 128 includes the phrase tokens 144 as a first subset of vertices, the popular key phrases 140 as a second subset of vertices, and edges 146 connecting the phrase tokens 144 to the popular key phrases 140. Notably, the bipartite graph 142 includes one vertex for each unique phrase token 144, e.g., even if the phrase token 144 occurs in multiple key phrases 132. The graph construction module 141 is configured to repeat the graph construction process to generate a bipartite graph 142 for each item category 128, and the bipartite graphs 142 are stored in the storage device 120. Further details regarding the bipartite graphs 142 and the storage thereof are provided below with reference to FIGS. 2 and 3.

In accordance with the described techniques, the key phrase recommendation system 106 obtains an item 118 associated with an item category 128 and an item title 126. By way of example, the key phrase recommendation system 106 obtains an item 118 having been listed on the online marketplace 112 within the item category 128. Moreover, the item title 126 is depicted as including title tokens 148, which are words, numbers, characters, and acronyms included in the item title 126. In particular, a token correspondence module 150 is configured to receive the item title 126 and tokenize the item title 126 into the title tokens 148. In an example of an item title 126 of “Echo Forge Gaming Headphones for PlaySphere,” the title tokens 148 include “Echo” “Forge,” “Gaming,” “Headphones,” and “PlaySphere.”

Generally, the token correspondence module 150 is configured to determine correspondence of title tokens 148 with key phrases 132 of the item category 128 using the bipartite graph 142 associated with the item category 128. To do so, the token correspondence module 150 accesses, from the storage device 120, the bipartite graph 142 associated with the item category 128 of the obtained item 118.

Furthermore, the token correspondence module 150 identifies relevant key phrases 152 using the bipartite graph 142. As part of this, the token correspondence module 150 identifies the phrase tokens 144 in the bipartite graph 142 that are also title tokens 148, e.g., matching tokens. Furthermore, the token correspondence module 150 identifies, as the relevant key phrases 152, the popular key phrases 140 in the bipartite graph that are connected by an edge 146 to at least one matching token.

In addition, the token correspondence module 150 uses the bipartite graph 142 to determine, for each relevant key phrase 152, a quantity 154 of the title tokens 148 included in the relevant key phrase 152. To determine the quantity 154 of a relevant key phrase 152, the token correspondence module 150 counts the number of different matching tokens that the relevant key phrase 152 is connected to via the edges 146. This process is repeated by the token correspondence module 150 to generate a quantity 154 for each relevant key phrase 152, such that the quantity 154 represents a number of phrase tokens 144 in the relevant key phrase 132 that co-occur with title tokens 148 in the item title 126.

As shown, the relevant key phrases 152 having the quantities 154 are provided as input to the ranking module 156, which is generally configured to rank and/or filter the relevant key phrases 152 based on the quantities 154. As part of this, the ranking module 156 determines a metric, defined herein as label title alignment, for each relevant key phrase 152. Broadly, the label title alignment of a relevant key phrase 152 is a relationship between the quantity 154 of the relevant key phrase 152 and a difference between the quantity 154 and the number of phrase tokens 144 in the relevant key phrase 152. For example, the label title alignment metric is defined by the following equation:

$$LTA = \frac{c}{\vert l \vert - c + 1}$$

In the equation above, LT A is the label title alignment, c is the quantity 154 of the relevant key phrase 152, and l is the number of phrase tokens 144 in the relevant key phrase 152. Notably, the LTA function is designed to reward (e.g., provide higher values of the LT A score) to relevant key phrases 152 having a higher proportion of the title tokens 148 included therein. For example, a three-word relevant key phrase 152 having two title tokens 148 included therein produces an LTA value of one, while a two-word relevant key phrase 152 having two title tokens 148 included therein produces an LTA value of two.

In addition, the ranking module 156 accesses, from the storage device 120, the recall counts 134 and search counts 136 of the relevant key phrases 152, as further discussed below with reference to FIG. 2. The ranking module 156 further forms a tuple for each relevant key phrase 152. A tuple for a relevant key phrase 152 includes the label title alignment of the relevant key phrase 152, the recall count 134 of the relevant key phrase 152, and the search count 136 of the relevant key phrase 152. Broadly, the ranking module 156 is configured to rank the relevant key phrases 152 based on the information contained within the tuples.

For example, the ranking module 156 orders the relevant key phrases 152 in descending order from highest label title alignment to lowest label title alignment. Furthermore, the ranking module 156 orders relevant key phrases 152 having a same label title alignment in descending order from highest search count 136 to lowest search count 136. Moreover, the ranking module 156 orders relevant key phrases having a same label title alignment and a same search count in ascending order from lowest recall count 134 to highest recall count 134.

Consider an example in which three relevant key phrases 152 have the same value of label title alignment. Here, a first relevant key phrase 152 has a search count 136 of ten and a recall count 134 of fifty, a second relevant key phrase 152 has a search count 136 of five and a recall count 134 of twenty-five, and a third relevant key phrase 152 has a search count 136 of five and a recall count 134 of fifty. In this example, the ranking module 156 ranks the relevant key phrases 152 in the following order: (1) the first relevant key phrase 152, (2) the second relevant key phrase 152, (3) the third relevant key phrase 152. This is because the first relevant key phrase has the highest search count 136. While the second and third relevant key phrases 152 have the same search count 136, the second relevant key phrase 152 has a lower recall count 134, and is therefore ranked higher.

In one or more implementations, the ranking module 156 outputs, as recommended key phrases 158, a top-ranked subset of the relevant key phrases 152, e.g., the ten highest ranked relevant key phrases. In particular, the recommended key phrases 158 are communicated to the computing device 102 for display in ranked order in a user interface of the application 110, e.g., of the online marketplace 112. In various implementations, the recommended key phrases 158 are communicated to the computing device 102 of a seller having listed the item 118 analyzed by the token correspondence module 150 and the ranking module 156. In this context, the recommended key phrases 158 represent query terms that the seller can bid on in order to promote the item 118 (e.g., move the listing 116 for the item 118 to a more prominent position in a search results page) when the recommended key phrase 158 is entered in the search feature of the online marketplace 112.

In various implementations, the key phrase recommendation system 106 is configured to prune (e.g., filter out) relevant key phrases 152 based on the quantities 154, and provide a retained subset of the relevant key phrases 152 to the ranking module 156 for ranking. Notably, the retained subset of the relevant key phrases 152 excludes the relevant key phrases 152 that are pruned. To carry out this pruning process, the token correspondence module 150 tracks the quantities 154 of the relevant key phrases 152 in count arrays, e.g., maintained in the storage device 120. After the quantities 154 are determined for each relevant key phrase 152, the token correspondence module 150 groups the relevant key phrases 152 based on the quantities 154, such that each group has one or more relevant key phrases 152 with a same quantity 154. Furthermore, the token correspondence module 150 is programmed with a minimum number of relevant key phrases 152 to send to the ranking module 156 for ranking. Given this, the token correspondence module 150 retains one or more groups associated with the highest quantities 154, while ensuring to retain at least the minimum number of relevant key phrases 152.

Consider an example in which the minimum number of relevant key phrases is twenty, and the token correspondence module 150 forms three groups-a first group of ten relevant key phrases 152 having a quantity 154 of one, a second group of ten relevant key phrases 152 having a quantity 154 of two, and a third group of fifteen relevant key phrases 152 having a quantity 154 of three. Here, the token correspondence module 150 keeps the relevant key phrases 152 in the second and third groups, and prunes the relevant key phrases 152 in the first group. In other words, there is a threshold group that pushes the retained key phrases 152 above the minimum number, and the entire threshold group is retained, e.g., while groups associated with quantities 154 below the threshold group are pruned. Indeed, in an example in which the threshold group includes relevant key phrases 152 having a quantity 154 of two, the token correspondence module 150 prunes the relevant key phrases 152 having quantities that are below two, e.g., a threshold.

In these implementations, the ranking module 156 performs the ranking in a similar manner as discussed above, but solely on the retained relevant key phrases 152. By filtering out relevant key phrases 152 before ranking, the described techniques reduce the number of relevant key phrases 152 for the ranking module 156 to rank and sort. This reduces the amount of computational resources (e.g., processing resources and memory resources) utilized to perform the ranking and the sorting, and also reduces the time it takes for the ranking module 156 to rank and sort the key phrases which, in turn, reduces overall system latency.

Conventional techniques for key phrase recommendation typically model the problem as an extreme multi-label classification (XMC) problem. Generally, training data for training an XMC models include item and key phrase pairs. An item is paired with a key phrase if the item is engaged with (e.g., clicked) at least a threshold number of times responsive to the key phrase being searched. Given this, training data used by conventional techniques is biased towards popular items. Indeed, while unpopular items make up a majority of the online marketplace, unpopular items typically receive sufficient engagement to be paired with just one key phrase in the training data. This implies that an item's lack of popularity means that the item is not relevant to a key phrase, which is not true. Rather, search features of online marketplaces use ranking algorithms which rank items based on engagement, with more frequently engaged items being ranked higher and displayed more prominently within search results pages. Thus, an item can be relevant to a user query or key phrase, but is not engaged with because it is unpopular and hence buried behind more popular items within the search results. Conventional XMC models inherit the popularity bias of the training data on which they are trained. As a result, these conventional models typically produce an insufficient number of key phrases (e.g., one key phrase) for unpopular items, which make up a majority (e.g., ninety percent) of the online marketplace 112.

Notably, a key phrase 132 “produces” search results when the key phrase 132 is searched as a user query or as part of a user query via the search feature. Further, the search results returned responsive to the user query (that corresponds to or includes the key phrase 132) are said to have been “produced” by searching the key phrase 132. In contrast to conventional techniques, the described techniques generate the recommended key phrases 158 independently of engagement data describing user interactions with the search results (e.g., listings 116 of items 118) that the key phrases 132 produce responsive to being searched. Rather, the described techniques generate the recommended key phrases 158 for an item 118 based on token correspondence between the item title 126 and the popular key phrases 140 that are within the item 118's item category 128. An item 118 is listed within an item category 128 regardless of the amount of engagement it has received. Given this, grouping the key phrases by item category 128 and recommending the key phrases based on correspondence with the item title 126 improves key phrase recommendations for unpopular items 118 by increasing the number of recommended key phrases 158 as compared to conventional techniques.

Another problem with conventional XMC models is that they tend to recommend tail key phrases rather than head key phrases. Notably, tail key phrases are more numerous in quantity but are searched less frequently, while head key phrases are less numerous in quantity but searched more frequently. Conventional XMC models recommend tail key phrases despite head key phrases being more relevant to an item, and being more desirable by sellers. The described techniques alleviate this problem by constructing the bipartite graphs from the popular key phrases 140 that meet the search count threshold, thereby increasing the number and/or proportion of head key phrases recommended as compared to conventional techniques.

Moreover, many conventional XMC models are neural models trained using supervised tagging techniques, which during training, update weights of the XMC model based on a loss function. In contrast, the described techniques rely on a graph-based approach, in which the construction of the bipartite graphs 142 (e.g., the training phase) does not involve such weight updates based on a loss function. Thus, the bipartite graphs 142 are generatable in significantly less time than conventional neural model-based approaches are trained. Furthermore, the size (e.g., in terms of memory) of the bipartite graphs 142 is significantly smaller than neural model-based approaches since model weights need not be stored. This benefit is further exaggerated by the space-saving techniques described below with reference to FIG. 2.

In addition, at inference time, the described techniques use lightweight graph traversal or lookup operations to identify the relevant key phrases 152 rather than the complex operations (e.g., matrix multiplications, activation functions, and the like) utilized by neural model-based approaches, which reduces computational complexity. As a result, the inference latency (e.g., the time between submission of the request for key phrase recommendations by a seller, and when the recommended key phrases 158 are returned to the computing device 102 for display) of the described techniques is significantly reduced, as compared to conventional techniques.

In addition, the described techniques tokenize the item title 126 into title tokens 148, identify the phrase tokens 144 that match the title tokens 148, and identify the relevant key phrases 152 using the matching tokens. By doing so, the described techniques reduce the permutations of the item title 126 that are processed. Indeed, a naïve approach would generate every possible permutation of the item title 126, and analyze the permutations as candidates for recommended key phrases. This is infeasible due to restrictions in latency and resources. In contrast, the described techniques, analyze as candidates for recommended key phrases 158, the relevant key phrases 152 that have at least one token in common with the item title 126. By reducing the number of permutations of the item title 126 that are analyzed, the described techniques further reduce computational complexity and inference latency, which improves computational performance.

Having considered an example of an environment, consider now a discussion of some example details of the techniques for key phrase recommendation based on token correspondence in accordance with one or more implementations.

FIG. 2 depicts an example 200 of indexing a storage device in accordance with the described techniques. In the example 200, the key phrase recommendation system 106 is configured to obtain an item 118 of an item category 128. In response, the key phrase recommendation system 106 is configured to obtain the bipartite graph 142 of the item category 128, as well as the recall counts 134 and search counts 136 of the popular key phrases 140 represented in the bipartite graph 142.

As part of this, the bipartite graphs 142 are stored in the storage device 120 in compressed sparse row (CSR) format. By way of example, the bipartite graphs 142 are represented in the example as CSR structures, such as CSR structure 202a, 202b, 202c, through 202n, in which n represents the number of item categories 128 of the online marketplace 112. In accordance with the CSR format, each unique phrase token 144 and each unique popular key phrase 140 of the bipartite graph 142 are represented as positive integers (e.g., numerical identifiers), to avoid string comparison and manipulation costs. Each row of a CSR structure of a bipartite graph 142 represents a popular key phrase 140 and includes a key phrase identifier as well as the token identifiers of the phrase tokens 144 to which it is connected via the edges 146. Storage in the CSR format reduces storage costs as compared to other storage formats.

In addition, a hashing data structure 204 is employed to map the item categories 128 to corresponding bipartite graphs 142 stored as the CSR structures 202a, 202b, 202c, . . . 202n. As part of this, the item categories 128 are similarly represented as positive integers, referred to as category identifiers or category IDs 206a, 206b, 206c, through 206n, in which n is the number of item categories 128 of the online marketplace 112. Here, the key phrase recommendation system 106 determines a category ID 206a of the item category 128 of the obtained item 118. Furthermore, the hashing data structure 204 generates a hash of the category ID 206a using a hashing function, and the hash of the category ID 206a maps to a CSR structure 202a of a particular bipartite graph 142a. In general, therefore, the key phrase recommendation system 106 uses the hashing data structure 204 to identify a particular bipartite graph 142a of the item category 128, as shown.

Moreover, the storage device 120 stores the recall counts 134 and search counts 136 in separate arrays, referred to herein as the recall array 208 and search array 210, respectively. Here, the key phrases 132 are represented as key phrase identifiers or key phrase IDs 212a, 212b, 212c, through 212n, in which n is the number of key phrases 132 of the online marketplace. Here, the recall array 208 maps the key phrase IDs to corresponding recall counts 134a, 134b, 134c, through 134n, in which n is the number of key phrases 132 of the online marketplace 112. For example, a key phrase ID 212a of a particular key phrase 132 maps to the recall count 134a of the particular key phrase 132 in the recall array 208. Moreover, the search array 210 maps the key phrase IDs to corresponding search counts 136a, 136b, 136c, through 136n, in which n is the number of key phrases 132 of the online marketplace 112. By way of example, the key phrase ID 212a of a particular key phrase 132 maps to the search count 136a of the particular key phrase 132 in the search array 210.

To obtain the recall count 134 and search count 136 of the popular key phrase 140a, the key phrase recommendation system 106 indexes the recall array 208 and the search array 210 with the key phrase ID 212a of the popular key phrase 140a. Here, the recall array 208 returns the recall count 134a of the popular key phrase 140a, and the search array 210 returns the search count 136a of the popular key phrase 140a. This operation is repeated to obtain recall counts 134 and search counts 136 of a plurality of popular key phrases 140 of the bipartite graph 142a. By storing the recall counts 134 and search counts 136 in separate arrays, the key phrase recommendation system 106 indexes the recall array 208 and the search array 210 in parallel in various implementations.

FIG. 3 depicts an example of key phrase recommendation in accordance with the described techniques. Here, the key phrase recommendation system 106 receives an item 118 listed via the listing platform 114 within the item category 128 of “Portable Audio & Headphone Replacement Parts & Tools.” Moreover, the item 118 has an item title of “Echo Forge Gaming Headphones for PlaySphere.” Here, the key phrase recommendation system 106 obtains the bipartite graph 142 of the item category 128 “Portable Audio & Headphone Replacement Parts & Tools,” in accordance with the techniques discussed above with reference to FIG. 2.

As shown, the bipartite graph 142 includes a plurality of phrase tokens 144 connected via edges 146 to the popular key phrases 140 in which the phrase tokens 144 occur. For example, the phrase token “Echo” is connected to the popular key phrases 140 “Echo Forge” and “Echo Headphones” because “Echo” is a token within these popular key phrases 140. In accordance with the described techniques, the item title 126 is tokenized to generate title tokens 148, “Echo,” “Forge,” “Gaming,” “Headphones,” and “PlaySphere.” Furthermore, the key phrase recommendation system 106 identifies the phrase tokens 144 in the bipartite graph 142 that are also (e.g., the same as) the title tokens 148, e.g., matching tokens. In the example 400, the matching tokens are illustrated with a hatch pattern.

Once the matching tokens are identified, the key phrase recommendation system 106 uses the bipartite graph 142 to determine the quantities 154 of title tokens 148 included in respective popular key phrases 140. For example, the key phrase recommendation system 106, for a given popular key phrase 140, counts the number of edges 146 connecting the recommended key phrase 140 to matching tokens. Here, for example, the popular key phrase 140 “Echo Forge” is connected via the edges to two matching tokens, and as such, the quantity 154 associated with the popular key phrase 140 “Echo Forge” is two. Notably, the relevant key phrases 152 include the popular key phrases 140 connected to at least one matching token, and exclude the popular key phrases 140 that are not connected to at least one matching token, e.g., “Earbuds Microphone.”

Using the quantities 154, the key phrase recommendation system 106 determines label title alignments 302 for each of the relevant key phrases 152, as shown. As previously mentioned, the following equation is used to do so, in which LTA is the label title alignment, c is the quantity 154 of the relevant key phrase 152, and l is the number of phrase tokens in the relevant key phrase 152:

$$LTA = \frac{c}{\vert l \vert - c + 1}$$

Consider the relevant key phrase 152 “Bluetooth Wireless Headphones” as an example. Here, the value of c is one, the value of l is three, and as such, the value of the label title alignment 302 is one-third.

In accordance with the described techniques, the ranking module 156 ranks the relevant key phrases 152 in descending order of the label title alignments 302. In the example 300, the key phrases “Echo Forge” and “Echo Headphones” both have a label title alignment of two. Thus, the key phrase recommendation system 106 obtains the recall count 134 and search count 136 of these key phrases using the techniques discussed above with reference to FIG. 2. Here, the key phrase “Echo Forge” has a higher search count 136 than the key phrase “Echo Headphones,” and as such, “Echo Forge” is ranked higher. Alternatively, “Echo Forge” and “Echo Headphones” have the same search count 136, but “Echo Forge” has a smaller recall count 134, and as such, “Echo Forge” is ranked higher.

Moreover, the relevant key phrases 152 are communicated to the computing device 102 as recommended key phrases 158 in the ranked order. The computing device 102 displays the recommended key phrase 158 in the ranked order in a user interface 304 of the online marketplace 112 and/or listing platform 114, as shown.

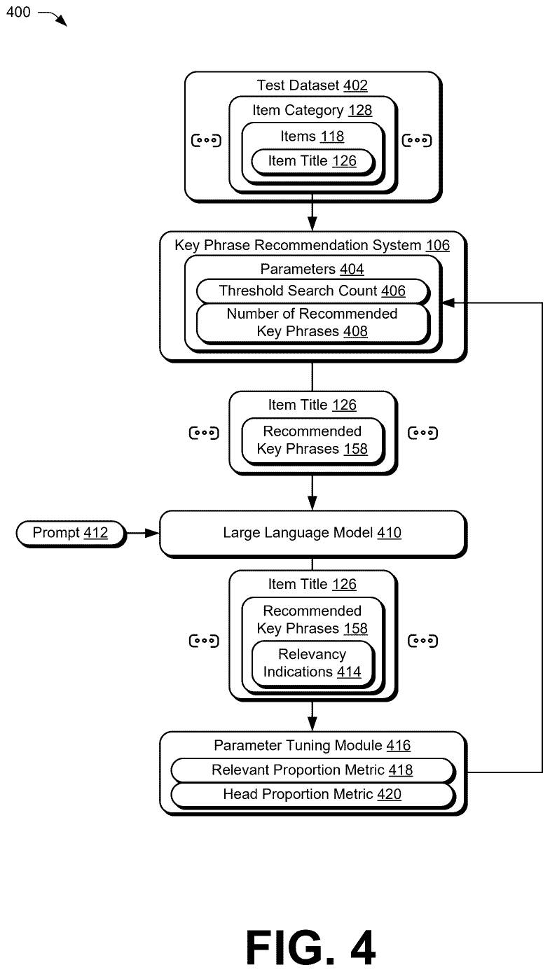

FIG. 4 depicts an example 400 of tuning parameters of a key phrase recommendation system. In the example 400, the key phrase recommendation system 106 receives a test dataset 402, including a plurality of item categories 128. Furthermore, each of the item categories 128 include a plurality of items 118 listed via the online marketplace 112 within the item category 128, and each item 118 includes an item title 126. Given an item category 128, the key phrase recommendation system 106 generates, for each item title 126 within the item category 128, recommended key phrases 158 in accordance with the described techniques. In doing so, the key phrase recommendation system 106 uses various tunable parameters 404, examples of which include a threshold search count 406 and a number of recommended key phrases 408. Here, the threshold search count 406 is used during the graph construction phase to filter out key phrases 132 that are below the threshold search count 406, and retain the popular key phrases 140 that satisfy the threshold search count 406. Moreover, the number of recommended key phrases 408 controls how many recommended key phrases 158 are output by the key phrase recommendation system 106.

As shown, the item titles 126 having the recommended key phrases 158 are provided as input to a large language model 410 along with a prompt 412. The large language model 410 is a pre-trained machine learning model trained on a variety of natural language processing (NLP) tasks such as question/prompt answering, examples of which include a Mixtral-8X7B model, generative pre-trained transformer (GPT) models, and a bi-directional encoder representations from transformers (BERT) model. Here, the prompt 412 instructs the large language model 410 to, given an item title 126 and a recommended key phrase 158, generate a relevancy indication 414 indicating whether the recommended key phrase 158 is relevant to the item title 126. Notably, the large language model 410 either outputs a positive relevancy indication 414 indicating that the recommended key phrase 158 is relevant to the item title 126, or a negative relevancy indication 414 indicating that that the recommended key phrase 158 is relevant to the item title 126. This process is repeated for each recommended key phrase 158 of an item title 126, and for each item title 126 within the item category 128.

Here, the item titles 126 including the recommended key phrases 158 and the relevancy indications 414 are provided as input data to a parameter tuning module 416. Based on the input data, the parameter tuning module 416 determines a relevant proportion metric 418 and a head proportion metric 420. Notably, the relevant proportion metric 418 is the percentage of recommended key phrases 158 across all item titles 126 within the item category 128 of the test dataset 402 having a positive relevancy indication. Furthermore, the head proportion metric 420 is the percentage of recommended key phrases 158 across all item titles 126 within the item category 128 of the test dataset 402 having a search count 136 that exceeds a threshold, which is a different value than (e.g., greater than) the threshold search count 406.

Furthermore, the parameter tuning module 416 updates the parameters 404 of the key phrase recommendation system 106 to increase the relevant proportion metric 418 and the head proportion metric 420. The above-described process is iteratively repeated on the test data of the same item category 128, but using the updated parameters 404. Furthermore, the parameter tuning module 416 determines, as the finalized parameters 404 of the item category 128, the combination of parameters 404 that maximizes the relevant proportion metric 418 and the head proportion metric 420. In this way, when an item 118 is received during inference within the item category 128, the key phrase recommendation system 106 generates the recommended key phrases 158 using the finalized parameters. This process is also performed on the different item categories 128 of the test dataset 402, e.g., to tune the parameters 404 of the key phrase recommendation system 106 for recommending different item categories 128. Due to this, during inference, the parameter tuning module 416 may use different sets of parameters 404 when generating recommended key phrases 158 for items 118 in different item categories 128.

Notably, the relevant proportion metric 418 and the head proportion metric 420 (or similar metrics) are also usable during an evaluation process to evaluate performance of the key phrase recommendation system 106 and/or compare performance of the key phrase recommendation system 106 to other approaches. One example comparison technique includes comparing the number of relevant key phrases and/or the number of head key phrases as output by the key phrase recommendation system 106 to a number of relevant key phrases and/or a number of head key phrases as output by some other key phrase recommendation approach on the same test data. Other evaluation/tuning metrics (e.g., precision, recall, F1 score) are insufficient for evaluating/tuning the key phrase recommendation system 106 due to the reliance of these metrics on ground truth labels. Since the key phrase recommendation system 106 (e.g., the bipartite graphs 142) is built in an unsupervised setting in which the popular key phrases 140 for items 118 are unknown during construction of the bipartite graphs (e.g., during a training phase), the key phrase recommendation system 106 does not use ground truth labels. It is for this reason that the relevant key phrase predictions (e.g., the relevant proportion metric 418) and the head key phrase predictions (e.g., the head proportion metric 420) are used to tune the parameters 404 and/or evaluate the system 106.

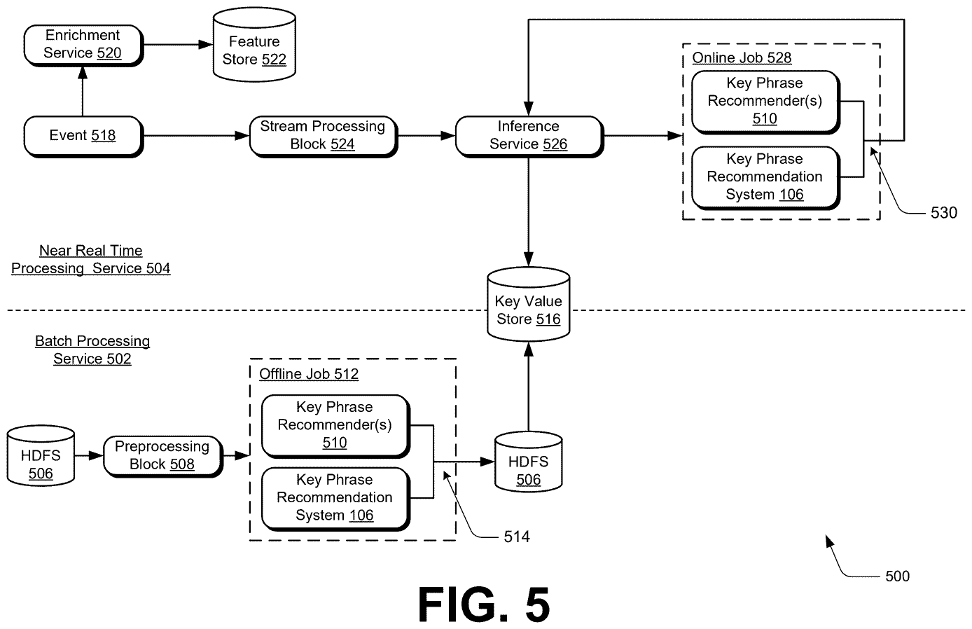

FIG. 5 is an example 500 of a serving architecture that is operable to employ techniques described herein. The example 500 includes a batch processing service 502, which is generally configured to periodically process items 118 listed via the online marketplace 112 using the key phrase recommendation system 106. For example, the batch processing service 502 periodically (e.g., daily) determines the recommended key phrases 158 for all items 118 listed via the online marketplace 112. Additionally or alternatively, the batch processing service 502 performs a daily differential. That is, the batch processing service 502 periodically (e.g., daily) determines the recommended key phrases for all items 118 that are newly listed during a previous time period, and all listings of items 118 that are updated/revised during the previous time period. The example 500 also includes a near real time processing service 504, which generates the recommended key phrases 158 urgently (e.g., in near real time) for an item 118 responsive to a new listing 116 being created for the item 118 or an update to an existing listing 116 for the item 118.

In accordance with the batch processing service 502, the raw data of the listings 116 of the online marketplace 112 is stored in a Hadoop Distributed File System (HDFS) 506. This data is processed by a preprocessing block 508 which is generally configured to perform one or more preprocessing operations on the raw data to format the data in a way that is processable by the key phrase recommendation system 106. By way of example, the preprocessing block 508 extracts key phrases 132 from user queries 130, and associates the key phrases 132 with recall counts 134, search counts 136, and item categories 128. The preprocessed data is provided as input to the key phrase recommendation system 106 and one or more key phrase recommenders 510. Broadly, the key phrase recommenders 510 are models and/or algorithms that generate key phrase recommendations using techniques and/or methods that differ from the key phrase recommendation system 106. In particular, the generation of key phrase recommendations is performed as part of an offline job 512, meaning that the computations are performed by a web services platform external to the service provider system 104. For example, the offline job 512 is performed by a data stream processing platform, such as Apache Flink.

As shown at 514, the results of the processing by the key phrase recommender(s) 510 and the key phrase recommendation system 106 are merged, and then stored in the HDFS 506. Once the data is fully processed (e.g., all listings 116 of the listing platform 114 are processed or all new or updated listings 116 of the listing platform 114 are processed), the data is stored in a key value store 516. For example, the item 118 is the “key” of an entry in the key value store, while the recommended key phrases 158 are the “values” of the entry in the key value store. When batch processing the entirety of data (e.g., all listings 116 of the listing platform 114), the batch processing service 502 additionally re-generates the bipartite graphs 142 of the item categories 128 in various implementations. This includes tuning the key phrase recommendation system 106 in accordance with the techniques discussed above with reference to FIG. 4. Since the training phase (e.g., the bipartite graph construction phase) of the key phrase recommendation system 106 is significantly faster than other approaches, daily model refreshes are possible enabling the key phrase recommendation system 106 to recommend new key phrases that arise daily on the online marketplace 112.

In accordance with the near real time processing service 504, an event 518 is received defining a new listing 116 being created or an update to an existing listing 116. The raw data of the event 518 is provided to an enrichment service 520, which generally is configured enrich the raw data (e.g., to generate the real-time listing data 122 including the attributes 124), and store the enriched data in a feature store 522. In addition, the event 518 is processed by a stream processing block 524, e.g., an Apache Flink processing window. Examples of operations performable by the stream processing block 524 include grouping events 518 by time window (e.g., grouping the events 518 received within a time interval) or count window (e.g., grouping a fixed number of events 518), and filtering (i.e., removing) irrelevant events 518, e.g., update events 518 in which the updated data does not impact key phrase recommendations.

After being processed by the stream processing block 524, the event 518 triggers calling of an inference service 526, which is a machine learning inference service of the service provider system 104 designed to handle real-time data processing and model inference at scale. In particular, the inference service 526 processes the newly listed or updated item 118 as an online job 528 (e.g., the processing is performed by hardware resources of the service provider system 104) using the key phrase recommender(s) 510 and the key phrase recommendation system 106. As shown at 530, the results of the processing are merged, and the inference service 526 stores the results in the key value store 516. For instance, the inference service 526 updates the key value store 516 to include a new entry (e.g., for a newly listed item 118) or updates an entry in the key value store 516, e.g., for an updated listing 116.

In other words, both the batch processing service 502 and the near real time processing service 504 inject data (e.g., item 118 and corresponding recommended key phrases 158) in the key value store 516. Recommended key phrases 158 are served (e.g., surfaced in user interfaces) to users of the online marketplace 112 from the key value store 516. Notably, the serving architecture depicted in the example 500 is highly scalable, e.g., to billions of items 118 and hundreds of billions of key phrases 132.

Having discussed exemplary details of key phrase recommendation based on token correspondence, consider now some examples of procedures to illustrate additional aspects of the techniques.

### Example Procedures

This section describes examples of procedures for key phrase recommendation based on token correspondence. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

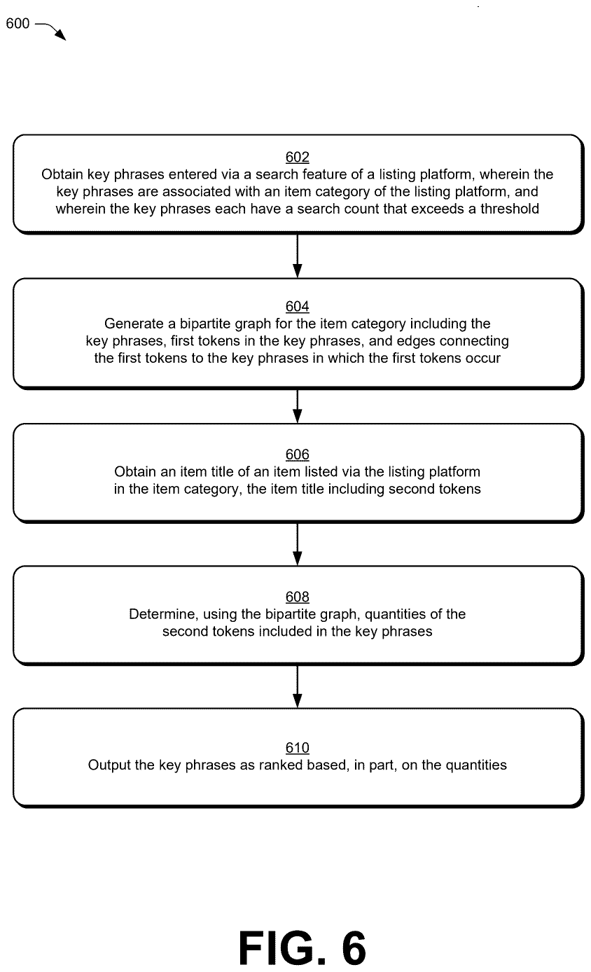

FIG. 6 depicts a procedure 600 in an example implementation of key phrase recommendation based on token correspondence. Key phrases entered via a search feature of a listing platform are obtained, the key phrases are associated with an item category of the listing platform, and the key phrases each have a search count that exceeds a threshold (block 602). By way of example, the key phrase recommendation system 106 receives key phrases 132 (e.g., user queries 130 or portions of user queries 130) entered via the search feature of the listing platform 114 of the online marketplace 112. Furthermore, the key phrase extraction module 138 identifies, as key phrases 132 associated with an item category 128, the key phrases 132 that, when entered via the search feature, return a top-ranked listing 116 within the item category 128. In addition, the key phrase extraction module 138 identifies, as the popular key phrases 140 of the item category 128, the key phrases 132 having a search count 136 that exceeds a threshold.

A bipartite graph is generated for the item category, and the bipartite graph includes the key phrases, first tokens in the key phrases, and edges connecting the first tokens to the key phrases in which the first tokens occur (block 604). For example, the graph construction module 141 receives the item category 128 and the popular key phrases 140 associated therewith. Based on this input data, the graph construction module 141 generates a bipartite graph 142 including the popular key phrases 140, phrase tokens 144 occurring in the popular key phrases 140, and edges 146 connecting the phrase tokens to the popular key phrases 140 in which the phrase tokens 144 occur.

An item title of an item listed via the listing platform in the item category is obtained, and the item title includes second tokens (block 606). For example, the token correspondence module 150 obtains an item 118 listed on the listing platform 114 of the online marketplace 112, and the item 118 is listed with an item title 126 and within the item category 128. Furthermore, the token correspondence module 150 tokenizes the item title 126 into title tokens 148.

Quantities of the second tokens included in the key phrases are determined using the bipartite graph (block 608). By way of example, the token correspondence module 150 identifies the phrase tokens 144 that are also title tokens 148, e.g., matching tokens. Furthermore, the token correspondence module 150 identifies relevant key phrases 152 that are connected to at least one matching token in the bipartite graph 142. For each relevant key phrase 152, the token correspondence module 150 counts a quantity 154 of the matching tokens connected to the relevant key phrase 152 in the bipartite graph 142 via the edges 146.

The key phrases are output as ranked based, in part, on the quantities (block 610). For example, the ranking module 156 determines a label title alignment for each relevant key phrase 152, which generally is a relationship between the quantity 154 of title tokens 148 in the relevant key phrase 152, and a difference between the quantity 154 and a number of phrase tokens 144 in the relevant key phrase 152. The ranking module 156 ranks the relevant key phrases 152 in descending order from highest label title alignment to lowest label title alignment. If multiple relevant key phrases 152 are assigned a same label title alignment, then the ranking module 156 ranks the multiple relevant key phrases 152 in descending order from highest search count 136 to lowest search count 136. If multiple relevant key phrases 152 are assigned a same label title alignment and a same search count, then the ranking module 156 ranks the multiple relevant key phrases 152 in ascending order from lowest recall count 134 to highest recall count 134. Then, the ranking module 156 outputs, as the recommended key phrases 158, a top-ranked subset of the relevant key phrases 152 for display in a user interface in the ranked order.

Having described examples of procedures in accordance with one or more implementations, consider now an example of a system and device that can be utilized to implement the various techniques described herein.

### Example System and Device

FIG. 7 illustrates an example of a system generally at 700 that includes an example of a computing device 702 that is representative of one or more computing systems and/or devices that may implement the various techniques described herein. This is illustrated through inclusion of the application 110 and the key phrase recommendation system 106. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random-access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

In some aspects, the techniques described herein relate to a method implemented by at least one computing device, the method including receiving a plurality of user queries entered via a search feature of a listing platform, extracting, from the plurality of user queries, key phrases associated with an item category of the listing platform, wherein the key phrases each have a search count that exceeds a threshold, obtaining an item title of an item listed via the listing platform in the item category, the item title including title tokens, ranking the key phrases based, in part, on quantities of the title tokens included in the key phrases, and outputting the ranked key phrases.

In some aspects, the techniques described herein relate to a method, wherein the key phrases are ranked independently of engagement data describing user interactions with search results that the key phrases produce responsive to being searched via the search feature.

In some aspects, the techniques described herein relate to a method, further including generating a data structure for the item category including the key phrases, additional tokens occurring in the key phrases, and edges connecting the additional tokens to the key phrases in which the additional tokens occur.

In some aspects, the techniques described herein relate to a method, wherein ranking the key phrases includes determining the quantities of the title tokens included in the key phrases using the data structure.

In some aspects, the techniques described herein relate to a method, wherein the search feature includes a ranking algorithm that ranks listings for presentation to a user, and extracting the key phrases includes associating a key phrase with the item category of a top-ranked listing as ranked by the ranking algorithm and retrieved responsive to the key phrase being searched via the search feature.

In some aspects, the techniques described herein relate to a method, wherein ranking the key phrases includes, for each respective key phrase of the key phrases, determining a first quantity of the title tokens included in the respective key phrase, determining a second quantity of total tokens included in the respective key phrase, and determining a relationship between the first quantity and a difference of the second quantity and the first quantity.

In some aspects, the techniques described herein relate to a method, wherein the key phrases are ranked based on the relationships.

In some aspects, the techniques described herein relate to a method, wherein ranking the key phrases includes identifying first key phrases of the key phrases having equal values of the relationships, and the first key phrases are ranked based on search counts of the first key phrases.

In some aspects, the techniques described herein relate to a method, wherein ranking the key phrases includes identifying second key phrases of the key phrases having equal values of the relationships and the search counts, and the second key phrases are ranked based on recall counts of search results that the key phrases produce responsive to being searched via the search feature.

In some aspects, the techniques described herein relate to a method, wherein ranking the key phrases includes identifying the key phrases having at least one of the title tokens included therein, pruning one or more of the key phrases having the quantities that are below an additional threshold, resulting in a retained subset of the key phrases, and ranking the pruned subset of the key phrases based, in part, on the quantities.

In some aspects, the techniques described herein relate to a system including one or more processors, and memory storing instructions that, when executed by the one or more processors, cause the system to obtain key phrases entered via a search feature of a listing platform, wherein the key phrases are associated with an item category of the listing platform, and wherein the key phrases each have a search count that exceeds a threshold, generate a data structure for the item category including the key phrases, first tokens in the key phrases, and edges connecting the first tokens to the key phrases in which the first tokens occur, obtain an item title of an item listed via the listing platform in the item category, the item title including second tokens, determine, using the data structure, quantities of the second tokens included in the key phrases, and output the key phrases as ranked based, in part, on the quantities.

In some aspects, the techniques described herein relate to a system, wherein the key phrases are ranked independently of engagement data describing user interactions with search results that the key phrases produce responsive to being searched via the search feature.

In some aspects, the techniques described herein relate to a system, wherein the search feature includes a ranking algorithm that ranks listings for presentation to a user, and the instructions further cause the system to associate a key phrase of the key phrases with the item category of a top-ranked listing as ranked by the ranking algorithm and retrieved responsive to the key phrase being searched via the search feature.

In some aspects, the techniques described herein relate to a system, wherein the instructions further cause the system, for each respective key phrase of the key phrases, to determine a first quantity of the first tokens included in the respective key phrase, determine a second quantity of the second tokens included in the respective key phrase, and determine a relationship between the second quantity and a difference of the first quantity and the second quantity.

In some aspects, the techniques described herein relate to a system, wherein the instructions further cause the system to rank the key phrases based on the relationships.

In some aspects, the techniques described herein relate to a system, wherein the instructions cause the system to identify first key phrases of the key phrases having equal values of the relationships, and the first key phrases are ranked based on search counts of the first key phrases.

In some aspects, the techniques described herein relate to a system, wherein the instructions cause the system to identify second key phrases of the key phrases having equal values of the relationships and the search counts, and the second key phrases are ranked based on recall counts of search results that the key phrases produce responsive to being searched via the search feature.

In some aspects, the techniques described herein relate to a system, wherein the instructions cause the system to receive a test dataset including a plurality of item titles within the item category, generate, using the data structure, recommended key phrases for each item title of the plurality of item titles, prompt a large language model to determine a first proportion of the recommended key phrases that are relevant to respective item titles of the plurality of item titles, determine a second proportion of the recommended key phrases having additional search counts that exceed an additional threshold, and tune one or more parameters of the data structure based on the first proportion and the second proportion.

In some aspects, the techniques described herein relate to a non-transitory computer-readable storage medium storing instructions that, when executed by one or more processors, cause the one or more processors to perform operations including obtaining key phrases entered via a search feature of a listing platform, wherein the key phrases are associated with an item category of the listing platform, and wherein the key phrases each have a search count that exceeds a threshold, generating a bipartite graph for the item category including the key phrases, first tokens in the key phrases, and edges connecting the first tokens to the key phrases in which the first tokens occur, obtaining an item title of an item listed via the listing platform in the item category, the item title including second tokens, and outputting the key phrases as ranked based, in part, on quantities of the second tokens included in the key phrases, the quantities extracted from the bipartite graph.

In some aspects, the techniques described herein relate to a non-transitory computer-readable storage medium, wherein the key phrases are ranked independently of engagement data describing user interactions with search results that the key phrases produce responsive to being searched via the search feature.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

1. A method implemented by at least one computing device, the method comprising:
receiving a plurality of user queries entered via a search feature of a listing platform;
extracting, from the plurality of user queries, key phrases associated with an item category of the listing platform, the key phrases each having been searched at least a threshold number of times via the search feature;
obtaining an item title of an item listed via the listing platform in the item category, the item title including title tokens;
ranking the key phrases by counting quantities of the title tokens that match phrase tokens in the key phrases; and
outputting the ranked key phrases.

2. The method of claim 1, wherein the key phrases are ranked independently of engagement data describing user interactions with search results that the key phrases produce responsive to being searched via the search feature.

3. The method of claim 1, further comprising generating a data structure for the item category including the key phrases, additional tokens occurring in the key phrases, and edges connecting the additional tokens to the key phrases in which the additional tokens occur.

4. The method of claim 3, wherein ranking the key phrases includes counting the quantities of the title tokens that match the phrase tokens using the data structure.

5. The method of claim 1, wherein the search feature includes a ranking algorithm that ranks listings for presentation to a user, and extracting the key phrases includes associating a key phrase with the item category of a top-ranked listing as ranked by the ranking algorithm and retrieved responsive to the key phrase being searched via the search feature.

6. The method of claim 1, wherein ranking the key phrases includes, for each respective key phrase of the key phrases:
counting a first quantity of the title tokens that match the phrase tokens in the respective key phrase;
determining a second quantity of the title tokens included in the respective key phrase; and
determining a relationship between the first quantity and a difference of the second quantity and the first quantity.

7. The method of claim 6, wherein the key phrases are ranked based on the relationships.

8. The method of claim 7, wherein ranking the key phrases includes identifying first key phrases of the key phrases having equal values of the relationships, and the first key phrases are ranked based on search counts of the first key phrases.

9. The method of claim 8, wherein ranking the key phrases includes identifying second key phrases of the key phrases having equal values of the relationships and the search counts, and the second key phrases are ranked based on recall counts of search results that the key phrases produce responsive to being searched via the search feature.

10. The method of claim 1, wherein ranking the key phrases includes:
identifying the key phrases having at least one phrase token that matches at least one title token of the item title;
pruning one or more of the key phrases having the quantities that are below an additional threshold, resulting in a retained subset of the key phrases; and
ranking the retained subset of the key phrases based, in part, on the quantities.

11. A system comprising:
one or more processors; and
memory storing instructions that, when executed by the one or more processors, cause the system to:
obtain key phrases entered via a search feature of a listing platform, wherein the key phrases are associated with an item category of the listing platform, and wherein the key phrases each having been searched at least a threshold number of times via the search feature;
generate a data structure for the item category including the key phrases, first tokens in the key phrases, and edges connecting the first tokens to the key phrases in which the first tokens occur;
obtain an item title of an item listed via the listing platform in the item category, the item title including second tokens;
count, using the data structure, quantities of the second tokens that match the first tokens in the key phrases; and
output the key phrases as ranked based, in part, on the quantities.

12. The system of claim 11, wherein the key phrases are ranked independently of engagement data describing user interactions with search results that the key phrases produce responsive to being searched via the search feature.

13. The system of claim 11, wherein the search feature includes a ranking algorithm that ranks listings for presentation to a user, and the instructions further cause the system to associate a key phrase of the key phrases with the item category of a top-ranked listing as ranked by the ranking algorithm and retrieved responsive to the key phrase being searched via the search feature.

14. The system of claim 11, wherein the instructions further cause the system, for each respective key phrase of the key phrases, to:
count a first quantity of the second tokens that match the first tokens in the respective key phrase;
determine a second quantity of the first tokens included in the respective key phrase; and
determine a relationship between the second quantity and a difference of the first quantity and the second quantity.

15. The system of claim 14, wherein the instructions further cause the system to rank the key phrases based on the relationships.

16. The system of claim 15, wherein the instructions cause the system to identify first key phrases of the key phrases having equal values of the relationships, and the first key phrases are ranked based on search counts of the first key phrases.

17. The system of claim 16, wherein the instructions cause the system to identify second key phrases of the key phrases having equal values of the relationships and the search counts, and the second key phrases are ranked based on recall counts of search results that the key phrases produce responsive to being searched via the search feature.

18. The system of claim 11, wherein the instructions cause the system to:
receive a test dataset including a plurality of item titles within the item category;
generate, using the data structure, recommended key phrases for each item title of the plurality of item titles;
prompt a large language model to determine a first proportion of the recommended key phrases that are relevant to respective item titles of the plurality of item titles;
determine a second proportion of the recommended key phrases having additional search counts that exceed an additional threshold; and
tune one or more parameters of the data structure based on the first proportion and the second proportion.

19. A non-transitory computer-readable storage medium storing instructions that, when executed by one or more processors, cause the one or more processors to perform operations comprising:
obtaining key phrases entered via a search feature of a listing platform, wherein the key phrases are associated with an item category of the listing platform, and wherein the key phrases each having been searched at least a threshold number of times via the search feature;
generating a bipartite graph for the item category including the key phrases, first tokens in the key phrases, and edges connecting the first tokens to the key phrases in which the first tokens occur;
obtaining an item title of an item listed via the listing platform in the item category, the item title including second tokens;
extracting, from the bipartite graph, quantities of the second tokens that match the first tokens in the key phrases;
outputting the key phrases as ranked based, in part, on quantities.

20. The non-transitory computer-readable storage medium of claim 19, wherein the key phrases are ranked independently of engagement data describing user interactions with search results that the key phrases produce responsive to being searched via the search feature.
